(19) United States
(12) Patent Application Publication
(10) Pub. No.: US 2026/0154603 A1
(43) Pub. Date: Jun. 4, 2026

(54) A Method of Training a Submodule and Preventing Capture of an AI Module

(71) Applicants: Robert Bosch GmbH, Stuttgart (DE); Robert Bosch Engineering and Business Solutions Private Limited, Bangalore (IN)

(72) Inventors: Adit Jignesh Shah, Ahmedabad (IN); Manojkumar Somabhai Parmar, Gujarat (IN); Shrey Arvind Dabhi, Bangalore (IN)

(21) Appl. No.: 18/704,639

(22) PCT Filed: Oct. 19, 2022
(86) PCT No.: PCT/EP2022/079080

§ 371 Date: Apr. 25, 2024

(30) Foreign Application Priority Data
Oct. 29, 2021 (IN) 2021 4104 9487

(51) Int. Cl. G06N 20/00; G06F 21/55

(52) U.S. Cl. CPC G06N 20/00; G06F 21/55

(57) ABSTRACT

A method of training a submodule and preventing capture of an AI module is disclosed. Input data received from an input interface is transmitted through a blocker module to an AI module, which computes a first output data by executing an AI model. A submodule in the AI system trained using methods steps processes the input data to identify an attack vector from the input data. The submodule comprises an xai classification model and at least a preprocessing block. The xai classification model runs a pre-trained AI model on xai signatures. The submodule distinguishes between a genuine input and an attack vector by identifying one or more xai signature features in the input.

### FIELD OF THE INVENTION

The present disclosure relates to a method of training a sub-module in an AI system and a method of preventing capture of an AI module in the AI system.

### BACKGROUND OF THE INVENTION

With the advent of data science, data processing and decision making systems are implemented using artificial intelligence modules. The artificial intelligence modules use different techniques like machine learning, neural networks, deep learning etc. Most of the AI based systems, receive large amounts of data and process the data to train AI models. Trained AI models generate output based on the use cases requested by the user. Typically the AI systems are used in the fields of computer vision, speech recognition, natural language processing, audio recognition, healthcare, autonomous driving, manufacturing, robotics etc. where they process data to generate required output based on certain rules/intelligence acquired through training.

To process the inputs and give a desired output, the AI systems use various models/algorithms which are trained using the training data. Once the AI system is trained using the training data, the AI systems use the models to analyze the real time data and generate appropriate result. The models may be fine-tuned in real-time based on the results. The models in the AI systems form the core of the system. Lots of effort, resources (tangible and intangible), and knowledge goes into developing these models.

It is possible that some adversary may try to capture/copy/extract the model from AI systems. The adversary may use different techniques to capture the model from the AI systems. One of the simple techniques used by the adversaries is where the adversary sends different queries to the AI system iteratively, using its own test data. The test data may be designed in a way to extract internal information about the working of the models in the AI system. The adversary uses the generated results to train its own models. By doing these steps iteratively, it is possible to capture the internals of the model and a parallel model can be built using similar logic. This will cause hardships to the original developer of the AI systems. The hardships may be in the form of business disadvantages, loss of confidential information, loss of lead time spent in development, loss of intellectual properties, loss of future revenues etc.

There are methods known in the prior arts to identify such attacks by the adversaries and to protect the models used in the AI system. The prior art US 20190095629A1—Protecting Cognitive Systems from Model Stealing Attacks discloses one such method. It discloses a method wherein the input data is processed by applying a trained model to the input data to generate an output vector having values for each of the plurality of pre-defined classes. A query engine modifies the output vector by inserting a query in a function associated with generating the output vector, to thereby generate a modified output vector. The modified output vector is then output. The query engine modifies one or more values to disguise the trained configuration of the trained model logic while maintaining accuracy of classification of the input data.

### BRIEF DESCRIPTION OF THE ACCOMPANYING DRAWINGS

An embodiment of the invention is described with reference to the following accompanying drawings:

FIG. 1 depicts an AI system;

FIG. 2 is a block-diagram for an submodule and an AI module;

FIG. 3 illustrates method steps of training a submodule in an AI system; and

FIG. 4 illustrates method steps to prevent capturing of an AI module in an AI system.

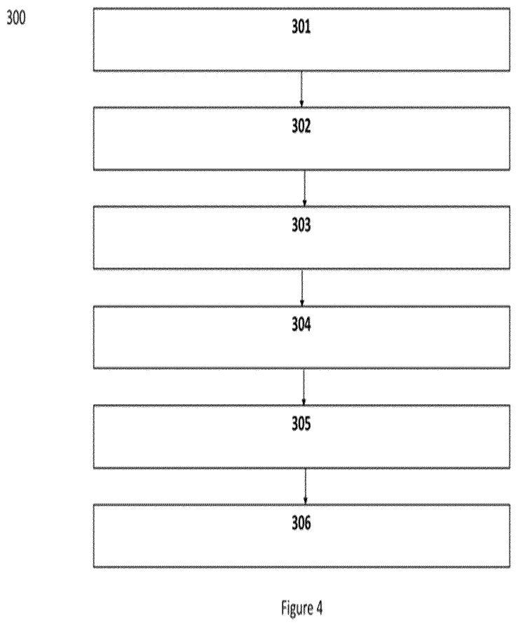

### DETAILED DESCRIPTION OF THE DRAWINGS

It is important to understand some aspects of artificial intelligence (AI) technology and artificial intelligence (AI) based systems or artificial intelligence (AI) system. This disclosure covers two aspects of AI systems. The first aspect is related to the training of a submodule in the AI system and second aspect is related to the prevention of capturing of the AI module in an AI system.

Some important aspects of the AI technology and AI systems can be explained as follows. Depending on the architecture of the implements AI systems may include many components. One such component is an AI module. An AI module with reference to this disclosure can be explained as a component which runs a model. A model can be defined as reference or an inference set of data, which is use different forms of correlation matrices. Using these models and the data from these models, correlations can be established between different types of data to arrive at some logical understanding of the data. A person skilled in the art would be aware of the different types of AI models such as linear regression, naïve bayes classifier, support vector machine, neural networks and the like. It must be understood that this disclosure is not specific to the type of model being executed in the AI module and can be applied to any AI module irrespective of the AI model being executed. A person skilled in the art will also appreciate that the AI module may be implemented as a set of software instructions, combination of software and hardware or any combination of the same.

Some of the typical tasks performed by AI systems are classification, clustering, regression etc. Majority of classification tasks depend upon labeled datasets; that is, the data sets are labelled manually in order for a neural network to learn the correlation between labels and data. This is known as supervised learning. Some of the typical applications of classifications are: face recognition, object identification, gesture recognition, voice recognition etc. Clustering or grouping is the detection of similarities in the inputs. The cluster learning techniques do not require labels to detect similarities. Learning without labels is called unsupervised learning. Unlabeled data is the majority of data in the world. One law of machine learning is: the more data an algorithm can train on, the more accurate it will be. Therefore, unsupervised learning models/algorithms has the potential to produce accurate models as training dataset size grows.

As the AI module forms the core of the AI system, the module needs to be protected against attacks. Attackers attempt to attack the model within the AI module and steal information from the AI module. The attack is initiated through an attack vector. In the computing technology a vector may be defined as a method in which a malicious code/virus data uses to propagate itself such as to infect a computer, a computer system or a computer network. Similarly an attack vector is defined a path or means by which a hacker can gain access to a computer or a network in order to deliver a payload or a malicious outcome. A model stealing attack uses a kind of attack vector that can make a digital twin/replica/copy of an AI module.

The attacker typically generates random queries of the size and shape of the input specifications and starts querying the model with these arbitrary queries. This querying produces input-output pairs for random queries and generates a secondary dataset that is inferred from the pre-trained model. The attacker then take this I/O pairs and trains the new model from scratch using this secondary dataset. This is black box model attack vector where no prior knowledge of original model is required. As the prior information regarding model is available and increasing, attacker moves towards more intelligent attacks. The attacker chooses relevant dataset at his disposal to extract model more efficiently. This is domain intelligence model-based attack vector. With these approaches, it is possible to demonstrate model stealing attack across different models and datasets.

It must be understood that the disclosure in particular discloses methodology used for training a submodule in an AI system and a methodology to prevent capturing of an AI module in an AI system. While these methodologies describes only a series of steps to accomplish the objectives, these methodologies are implemented in AI system, which may be a combination of hardware, software and a combination thereof.

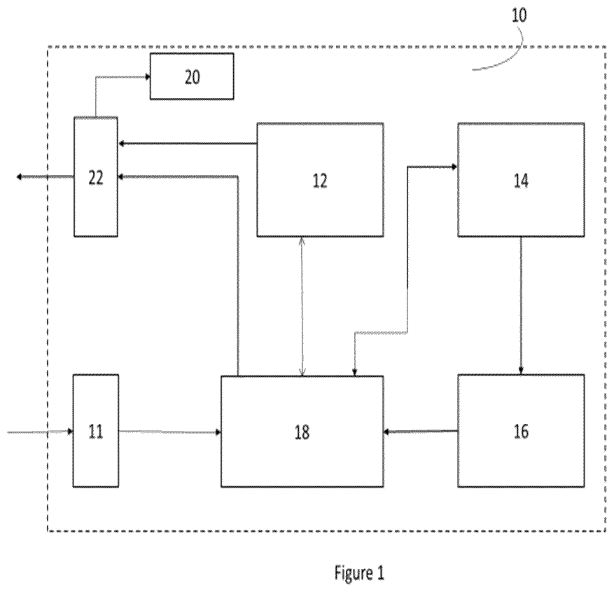

FIG. 1 depicts an AI system (10). The AI system (10) comprises an input interface (11), a blocker module (18), an AI module (12), a submodule (14), a blocker notification module (20), an information gain module (16) and at least an output interface (22). The input interface (11) receives input data from at least one user. The input interface (11) is a hardware interface wherein a used can enter his query for the AI module (12).

A module with respect to this disclosure can either be a logic circuitry or a software programs that respond to and processes logical instructions to get a meaningful result. A hardware module may be implemented as any or a combination of: one or more microchips or integrated circuits interconnected using a parent board, hardwired logic, software stored by a memory device and executed by a microprocessor, firmware, an application specific integrated circuit (ASIC), and/or a field programmable gate array (FPGA).

As explained above, these various modules can either be a software embedded in a single chip or a combination of software and hardware where each module and its functionality is executed by separate independent chips connected to each other to function as the system. For example, a neural network (in an embodiment the AI module) mentioned herein after can be a software residing in the system or the cloud or embodied within an electronic chip. Such neural network chips are specialized silicon chips, which incorporate AI technology and are used for machine learning.

The blocker module (18) is configured to block a user based on the information gain. Information gain is calculated when input attack queries exceeds a predefined threshold value. The blocker module (18) is further configured to modify a first output generated by an AI module (12). This is done only when the input is identified as an attack vector.

The AI module (12) to process said input data and generate the first output data corresponding to said input. The AI module (12) executes a first model (M) based on the input to generate a first output. This model could be any from the group of artificial neural networks, convolutional neural networks, recurrent neural networks and the like.

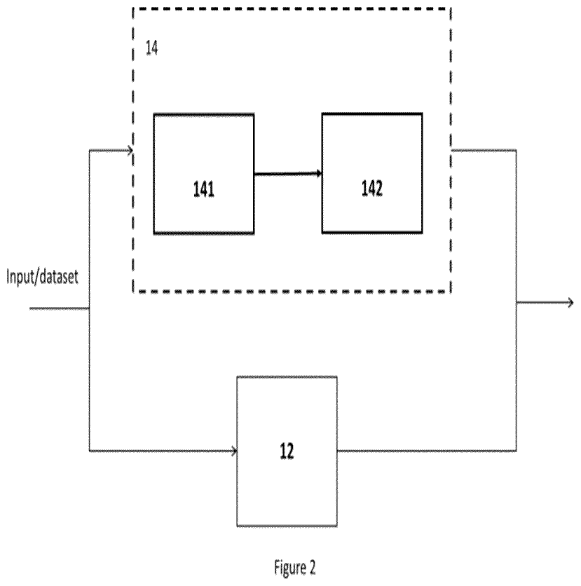

The submodule (14) is configured to identify an attack vector from the received input data. FIG. 2 is a block-diagram for an submodule and an AI module. The submodule (14) comprises an xai classification model (142) and at least a preprocessing block (142). Explainable artificial intelligence (XAI) (hereinafter mentioned as “xai”) model allows human users to comprehend the results and output generated by the AI model. Explainable AI is used to describe an AI models operations and decision making by revealing the relationship of variables and its relative importance along with their interactions. XAI is also helpful in identifying potential biases, issues with fairness and transparency in AI-powered decision making. Black-box Models represents the models that are too complex to interpret for example the Deep Learning models. These black box models are created directly from the data and even the data scientists who create the models can't always understand or explain what or how the AI models arrived at a specific result. Building an XAI model focuses on different techniques to break the black-box nature of Machine Learning models and produce human-level explanations.

A person skilled in the art would be aware of the various strategies introduced for explaining an AI model, for example the Deep LIFT method that uses back propagation through all of the neurons in the network to explain the output or the SHAP (Shapley Additive explanation) method, which aims to explain the model output using shapely values (a concept of the famous game theory). The Shapley value is the average marginal contribution of a feature value across all possible coalitions. The SHAP uses this concept of game theory to connect optimal credit allocation with local explanations using the classic Shapley values from game theory and their related extensions.

The xai classification model (142) runs a pre-trained AI model on xai signatures. The xai classification model (142) runs the same class of AI model as the AI module (12). For example in an embodiment of the present invention, if the AI module (12) executes a first model (M) that is a convolutional neural network, the xai classification model (142) is also a convolutional neural network. The preprocessing block (142) samples the input data or the training dataset. It further extracts the xai signatures input data or the training dataset. The submodule (14) when working in the AI system (10) helps in distinguishing between a genuine input and an attack vector by identifying one or more xai signature features in the input. The submodule (14) generates a second output. In the working of the AI system (10) this second input is compared with the first output. The output final sent by the output interface (22) comprises the first output data when the submodule (14) doesn't identify an attack vector from the received input.

The blocker notification module (20) transmits a notification to the owner of said AI system (10) on detecting an attack vector. The notification could be transmitted in any audio/visual/textual form.

The information gain module (16) is configured to calculate an information gain and send the information gain value to the blocker module (18). The information gain is calculated using the information gain methodology. In one embodiment, if the information gain extracted exceeds a pre-defined threshold, the AI system (10) is configured to lock out the user from the system. The locking out the system is initiated if the cumulative information gain extracted by plurality of users exceeds a pre-defined threshold.

The output interface (22) is sends output to said at least one user. The output sent by the output interface (22) comprises the first output data when the submodule (14) doesn't identify an attack vector from the received input. The output sent by the output interface (22) comprises a modified output received from the blocker module (18), when an attack vector is detected from the input.

It must be understood that each of the building blocks of the AI system (10) may be implemented in different architectural frameworks depending on the applications. In one embodiment of the architectural framework all the building block of the AI system (10) are implemented in hardware i.e. each building block may be hardcoded onto a microprocessor chip. This is particularly possible when the building blocks are physically distributed over a network, where each building block is on individual computer system across the network. In another embodiment of the architectural framework of the AI system (10) are implemented as a combination of hardware and software i.e. some building blocks are hardcoded onto a microprocessor chip while other building block are implemented in a software which may either reside in a microprocessor chip or on the cloud.

FIG. 2 illustrates method steps (200) of training a submodule (14) in an AI system (10). The AI system (10) comprises the components described above in FIGS. 1 and 2. The submodule (14) is trained using a dataset used to train the AI module (12). The submodule (14) is explained in accordance with FIG. 2.

Method step 201 comprises preprocessing the dataset to derive xai signatures of the dataset. In one embodiment of the present invention, pre-processing further comprises sampling the dataset to reduce size and computational load need for training the submodule. Basically, we create a database consisting of the xai signature of the dataset. Since the generation of the xai signatures is very time-consuming process, optionally a random sampling of the dataset is suggested. In an embodiment of the present invention, the xai signature is derived using deep Ex-plainer using SHAP.

Method step 202 comprises executing an xai classification model (142) with the derived xai signatures of the dataset. Then the model is trained using the data from the database which will classify the xai signature. Method step 203 comprises recording the output of the xai classification model (142).

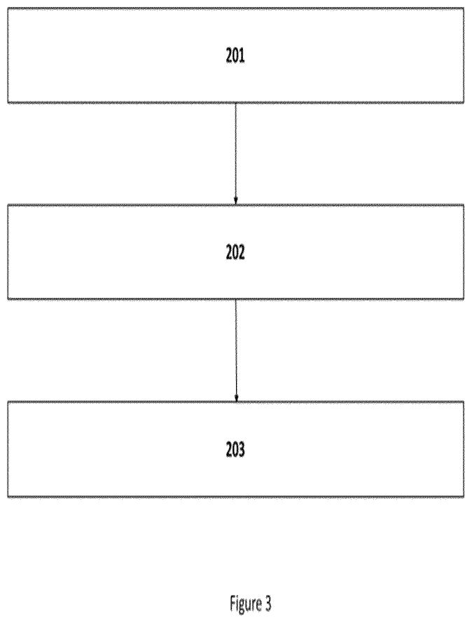

FIG. 3 illustrates method steps (300) to prevent capturing of an AI module (12) in an AI system (10). The AI system (10) and its components have been explained in the preceding paragraphs by means of FIGS. 1 and 2. A person skilled in the art will understand that the submodule (14) trained by the method steps (200) is now used in real time for preventing capture of an AI module (12) in an AI system (10).

In method step 301, input interface (11) receives input data from at least one user. In step 302, this input data is transmitted through a blocker module (18) to an AI module (12). In step 303, the AI module (12) computes a first output data based on the input data.

In step 304, input is processed by submodule (14). This method step further comprises preprocessing the input data to extract xai features in the input data; executing an xai classification model (142) with the extracted xai features; recording an output of the xai classification model (142). Important aspects of the xai technology have been explained above with reference to FIG. 2. In one embodiment of the present invention, pre-processing comprises sampling the input to reduce size and computational load need for training the submodule. Basically, we create a database consisting of the xai signature of the input. Since the generation of the xai signatures is very time-consuming process, optionally a random sampling of the input is suggested. In an embodiment of the present invention, the xai signature is derived using deep Ex-plainer using SHAP as explained in para [0006].

In step 305, the first output and the second output are compared to identify an attack vector from the input data, the identification information of the attack vector is sent to the information gain module (16). The output of the AI model (M) and xai classification model (142) based on xai value is compared. If the difference in xai value exceeds a predefined threshold and beyond a certain number of times for a batch of inputs, the input is deemed to be an attack vector. Once an attack vector is identified either the output is given as the opposite class to the actual class or a random class.

Once the attack vector identification information is sent to the information gain module (16), an information gain is calculated. The information gain is sent to the blocker module (18). In an embodiment, if the information gain exceeds a pre-defined threshold, the user is blocked and the notification is sent the owner of the AI system (10) using blocker notification module (20) (method step 306). If the information gain is below a pre-defined threshold, although an attack vector was detected, the blocker module (18) may modify the first output generated by the AI module (12) to send it to the output interface (22).

In addition, the user profile may be used to determine whether the user is habitual attacker or was it one time attack or was it only incidental attack etc. Depending upon the user profile, the steps for unlocking of the system may be determined. If it was first time attacker, the user may be locked out temporarily. If the attacker is habitual attacker, then a stricter locking steps may be suggested.

It must be understood that the embodiments explained in the above detailed description are only illustrative and do not limit the scope of this invention. Any modification to a method of training a submodule (14) and preventing capture of an AI module (12) are envisaged and form a part of this invention. The scope of this invention is limited only by the claims.

1. An AI system, comprising:
an input interface configured to receive input from at least one user;
a blocker module configured to block at least one user;
an AI module configured to process said input data and generate first output data corresponding to said input;
a submodule configured to identify an attack vector from the received input, the submodule further comprising an xai classification model and at least a preprocessing block;
an information gain module configured to calculate an information gain and send the information gain value to the blocker module;
a blocker notification module configured to transmit a notification to the owner of said AI system on detecting an attack vector, the blocker notification module further being configured to modify a first output generated by an AI module; and
an output interface configured to send an output to said at least one user.

2. The AI system as claimed in claim 1, wherein the output sent by the output interface comprises the first output data when the submodule doesn't identify an attack vector from the received input.

3. The AI system as claimed in claim 1, wherein the submodule is configured to distinguish between a genuine input and an attack vector by identifying one or more xai signature features in the input.

4. A method of training a submodule in an AI system said AI system comprising at least an AI module and a dataset used to train the AI module said method comprising:
preprocessing the dataset to derive xai signatures of the dataset;
executing an xai classification model with the derived xai signatures of the dataset; and
recording the output of the xai classification model.

5. The method of training a submodule in an AI system as claimed in claim 4, wherein preprocessing further comprises sampling the dataset.

6. A method to prevent capturing of an AI module in an AI system, comprising:
receiving input data from at least one user through an input interface;
transmitting input data through a blocker module to an AI module;
computing a first output data by the AI module based on the input data;
processing input data by a submodule to compute a second output;
comparing the first output with the second output to identify an attack vector from the input data, the identification information of the attack vector being sent to the information gain module; and
blocking at least one user through the blocker module based on information from the information gain module.

7. The method to prevent capturing of an AI module in an AI system as claimed in claim 6, wherein processing the input data further comprises:
preprocessing the input data to extract xai features in the input data;
executing an xai classification model with the extracted xai features; and
recording an output of the xai classification model.

8. The method to prevent capturing of an AI module in an AI system as claimed in claim 6, wherein preprocessing further comprises sampling the input data.
